(19) United States
(12) Patent Application Publication
(10) Pub. No.: US 2016/0100633 A1
(43) Pub. Date: Apr. 14, 2016

(54) Electronic cigarette

(71) Applicant: VAPEONLY TECHNOLOGY CO., LTD., Shenzhen (CN)

(72) Inventor: Eric Gao, Shenzhen (CN)

(73) Assignee: VAPEONLY TECHNOLOGY CO., LTD.

(21) Appl. No.: 14/948,974

(22) Filed: Nov. 23, 2015

(30) Foreign Application Priority Data
Aug. 14, 2015 (CN) 201510501900.9
Aug. 14, 2015 (CN) 201520616128.0

(51) Int. Cl. A24F 47/00; H05B 1/02

(52) U.S. Cl. CPC A24F 47/008; H05B 1/0244

(57) ABSTRACT

An electronic cigarette includes a mouth piece; a top unit with air inlets provided at a top portion thereof; an atomizer core, including a first shell with an electronic cigarette flavoring liquid inlet, a slow penetration unit, a heater and a first electrode; an electronic cigarette flavoring liquid tank including a second shell and a second electrode, wherein both the atomizer core and the electronic cigarette flavoring liquid tank have a hollow with a sealed bottom and a opened top, the atomizer core is installed at a bottom portion of the top unit, and is loaded in through a top portion of the electronic cigarette flavoring liquid tank; and a power and control unit, including a third shell and a third electrode, wherein a battery is provided therein for supplying electricity; wherein shells and electrodes are insulated from each other.

### CROSS REFERENCE OF RELATED APPLICATION

The present invention claims priority under 35 U.S.C. 119(a-d) to CN 201510501900.9, filed Aug. 14, 2015, and 201520616128.0, filed Aug. 14, 2015.

### BACKGROUND OF THE PRESENT INVENTION

1. Field of Invention

The present invention relates to a novel electronic cigarette, and more particularly to a novel electronic cigarette whose electronic cigarette flavoring liquid will not be leaked and splash back into the mouth of the person who is using the electronic cigarette.

2. Description of Related Arts

Electronic cigarette is a newly-developed steam smoking consuming electronic product. Through electric heating, an oil-like material commonly known as “electronic cigarette flavoring liquid” or a cream-like material commonly known as “electronic cigarette flavoring cream” is vaporized for generating smog-like steam. Because no toxic substances such as tar and CO are generated, the electronic cigarette is healthier. In addition, “electronic cigarette flavoring liquid” and “electronic cigarette flavoring cream” are far tastier than traditional cigarettes, and nicotine content thereof is more selectable. Therefore, the electronic cigarette is healthier and more diversity of personal choice. The electronic cigarette comprises a rechargeable electric core, a control circuit and an atomizer.

Although the electronic cigarette has a lot of advantages, there are still some unsolved problems thereof. For example:

1) Conventionally, the electronic cigarette flavoring liquid is easy to be splashed into the mouth during smoking the electronic cigarette.

2) Conventionally, an electronic cigarette flavoring liquid tank of the electronic cigarette is easy to be detached by mistake or loosened, resulting in leakage of the electronic cigarette flavoring liquid. Furthermore, with a through structure that air flows upwards, the electronic cigarette flavoring liquid is easy to be leaked from an air inlet.

3) Conventionally, atomizing efficiency of the electronic cigarette is too low, when the liquid is over supplied, it results in serious splashing and bad taste.

4) Conventionally, errors of the electronic cigarette are not able to be clearly recognized when error types are more than two without screen display.

Referring to Chinese patent CN203873010U, an electronic cigarette and a leakage-proof device are disclosed. Accordingly, with a microporous filtering net, electronic cigarette flavoring liquid leakage of the electronic cigarette is effectively prevented while air flow is guaranteed.

Referring to Chinese patent CN203913381U, an electronic cigarette is disclosed, comprising a mouth piece, an atomizer, and a battery rod. Accordingly, the electronic cigarette is able to prevent electronic cigarette flavoring liquid leakage and steam condensate leakage, and an electronic cigarette flavoring liquid content in the atomizer is not observable.

Referring to Chinese patent CN203692552U, an electronic cigarette is disclosed. Accordingly, the electronic cigarette has a steam tunnel and an air tunnel, wherein the steam tunnel and the air tunnel communicate with an external surface of a mouth piece and are isolated from each other. An air flow responding controlling unit is provided inside the air tunnel, for controlling a battery component to supply the atomizer. Because the air flow responding controlling unit of the electronic cigarette is provided inside the air tunnel, no electronic cigarette flavoring liquid will be adhered thereon even if steam flows back. Therefore, reliability is improved as well as stability of steam amount, the electronic cigarette flavoring liquid is not easy to be leaked, there is no such problem that a joint portion between an electronic cigarette flavoring liquid tank and a main body of the electronic cigarette is easy to be bent which results in crack and electronic cigarette flavoring liquid leakage, and overcomes a defect that the electronic cigarette flavoring liquid is sucked into a mouth of a user.

Referring to Chinese patent CN203538370U, an electronic cigarette and an atomizer component, wherein the atomizer comprises a mouth piece, which is integrated through double-color injection molding and a sealing element, in such a manner that the mouth piece has a sealing function, for sealing a gap between a mouth piece cap and an external casting pipe, so as to eliminate a leakage tunnel and prevent leakage.

According to the above references, different technical schemes are used for solving insufficient atomizing and electronic cigarette flavoring liquid leakage, but there are still some defects. Furthermore, it is still impossible to recognize and detect different errors without writing prompts.

### SUMMARY OF THE PRESENT INVENTION

According to the problems described in the Description of Related Arts, an object of the present invention is to provide a novel electronic cigarette, wherein electronic cigarette flavoring liquid thereof will not be leaked and splashed into a mouth, atomizing is sufficient, and different errors are able to be recognized and detected without writing prompts.

Accordingly, in order to accomplish the above object, the present invention provides:

an electronic cigarette, wherein: from a top to a bottom, the electronic cigarette comprises a mouth piece which is detachable, a top unit, an atomizer core, an electronic cigarette flavoring liquid tank and a power and control unit in sequence, wherein

a bottom portion of the mouth piece is detachably connected to a top portion of the top unit;

the top unit is connected to the mouth piece and the atomizer core, and has air inlets; wherein after entering the atomizer core through the air inlets, air flow is thoroughly mixed with atomizing steam in the atomizer core, then the air flow passes through the top unit, the mouth piece, and finally enters a mouth of a user;

the atomizer core comprises a first shell; a slow penetration unit is closely pressed against an internal wall of the first shell; an oil inlet, which allows electronic cigarette flavoring liquid in the electronic cigarette flavoring liquid tank to enter the slow penetration unit, is provided on the first shell, and a heater is closely pressed against the slow penetration unit; a first electrode is provided at a bottom portion of the first shell, and a first insulating seal is provided between the first shell and the first electrode; a first pole of the heater is electrically contacted with the first electrode, a second pole of the heater is electrically contacted with the first shell; the bottom portion of the first shell is sealed through shrink fit of the first insulation seal, the first shell and the first electrode; a top portion of the first shell is opened, so as to form a hollow structure having a sealed bottom and an opened top; the atomizer core is loaded in from a top portion of the electronic cigarette flavoring liquid tank, and a top portion of the atomizer core is detachably connected to a bottom portion of the top unit;

the electronic cigarette flavoring liquid tank comprises a second shell and a second electrode provided at a bottom portion of the second shell, wherein a second insulating seal is provided between the second shell and the second electrode, the bottom portion of the second shell is sealed through shrink fit of the second insulating seal, the second shell and the second electrode; a top portion of the second shell is opened, so as to form a hollow structure of the electronic cigarette flavoring liquid storage, which has a sealed bottom and an opened top; the electronic cigarette flavoring liquid tank is detachably connected to a top portion of the power and control unit;

the power and control unit comprises a third shell and a third electrode provided at a top portion of the third shell, wherein a third insulation seal is provided between the third shell and the third electrode, for insulating sealing therebetween; a battery inside the power and control unit supply the electronic cigarette, and output or cut off a current through a power switch;

after assembling, the first pole of the heater of the atomizer core is connected to a first pole of the battery inside the power and control unit through the first electrode, the second electrode and the third electrode in sequence; the second pole of the heater of the atomizer core is connected to a second pole of the battery inside the power and control unit through the first shell, the second shell and the third shell in sequence; all the parts form a complete current loop; the heater of the atomizer core is supplied by the power and control unit for atomizing the electronic cigarette flavoring liquid.

Preferably, two eccentric tunnels are provided inside the mouth piece, and communicate with each other in a roundabout form; cross sections of the two eccentric tunnels are tangent with each other or not intersected at all.

Preferably, the top unit comprises a connecting supporter at the top portion thereof, an air inlet tunnel is provided inside the connecting supporter; a decoration is externally provided on the connecting supporter, which surrounds the air inlet tunnel and keeps a plurality of the air inlets; preferably, the air inlets are arranged in a 360 loop form, for loop air intake; the air inlets are connected to the air inlet tunnel, and an air outlet slot is provided at a bottom portion of the connecting supporter;

the top unit further comprises a first seal provided at an external wall of the top unit where the mouth piece is mounted, a second seal provided at an assembling position of the top unit and the atomizer core, and a third seal provided at an assembling position of the top unit and the electronic cigarette flavoring liquid storage;

a connector is provided at the assembling position of the top unit and the atomizer core.

Preferably, a double-layer air tunnel is provided inside the top unit, comprising an inner air tunnel tube and an outer air tunnel tube;

with the top unit, the air flow passes through the air inlet, the air inlet tunnel and the outer air tunnel tube in sequence, so as to enter a hollow portion of the atomizer core; after being thoroughly mixed with the atomizing steam, the air flow turns upwards and passes through the inner air tunnel tube and the mouth piece in sequence, so as to finally enter the mouth of the user.

Preferably, the second shell comprises a first top supporter, a side hole tube, and a first bottom supporter, wherein the first top supporter has a hollow structure having an opened top, and is connected to the first bottom supporter through the side hole tube; the second electrode is provided at a bottom portion of the first bottom supporter; the second electrode compresses the second insulating seal, for provide shrink fit with the first bottom supporter; an inner diameter of the first bottom supporter is no more than an outer diameter of the first shell, or the inner diameter of the first bottom supporter is larger than the outer diameter of the first shell; a hole is drilled on the side hole tube for observing an electronic cigarette flavoring liquid content; the electronic cigarette flavoring liquid storage further comprises a transparent unit, wherein the transparent unit is mounted at a middle of the side hole tube by a fourth seal at a top face thereof and a fifth seal at a bottom face thereof with an elastic effect; the first top supporter, the side hole tube and the first bottom supporter are all electrically conductive.

Preferably, when an inner diameter of the side hole tube is larger than an outer diameter of transparent unit, the transparent unit is cased by the side hole tube; when the inner diameter of the side hole tube is smaller than the outer diameter of the transparent unit, the side hole tube is cased by the transparent unit.

Preferably, the third shell comprises a second top supporter, a thin-walled tube, and a second bottom supporter, wherein the second top supporter is connected to the second bottom supporter through the thin-walled tube; the third electrode is provided at an opening of the top supporter; the third insulating seal is provided between the third shell and the third electrode for insulation thereof; and a air vent is provided on the second bottom supporter;

the air vent is provided on the second bottom supporter; the power and control unit further comprises a control circuit, the battery, the power switch and an USB (universal serial bus) interface; wherein after receiving a trigger signal from the power switch, the control circuit outputs or cuts off the current;

the USB interface is for charging and data transmitting.

Preferably, the control circuit is a single-layer PCB (printed circuit board) or a multi-layer PCB, the control circuit is horizontally arranged, which is perpendicular to an axial direction of the electronic cigarette.

Preferably, the control circuit is connected to a light tube, suitable LED; wherein by setting light tips with different colors and twinkle frequencies for the control circuit, different light combinations are respectively corresponding to a short circuit alarm, a low resistance protection alarm, an open circuit alarm, a low voltage alarm, a working overtime alarm, an overheat protection alarm, and a battery overload alarm, in such a manner that the user clearly judges an error condition.

Preferably, through screw threads, clips, or tight fits, the top portion of the top unit is detachably connected to the mouth piece, the bottom portion of the top unit is detachably connected to the atomizer core, the top unit is detachably connected the top portion of the electronic cigarette flavoring liquid tank, and the electronic cigarette flavoring liquid tank is detachably connected to the top portion of the power and control unit;

an individual assembly formed by the mouth piece, the top unit, the atomizer core and the electronic cigarette flavoring liquid tank, and the individual power and control unit are two essential replaceable units of the electronic cigarette, which are replaceable with other electronic cigarettes.

Materials used in different parts of the present invention are as follows:

1) For the mouth piece, a material thereof is preferably metal, ceramics, glass, wood, bamboo, and plastic, which meet the food safety standards.

2) For the top unit: materials of the connecting supporter and the connector are metals with sufficient electrical conductivity, preferably: stainless steel and chrome-plated brass; a material of the decoration is an eco-friendly metal, preferably: stainless steel, chrome-plated brass; materials of the inner air tunnel tube and the outer air tunnel tube are eco-friendly hollow thin-walled metal pipes, preferably: stainless steel and chrome-plated brass; materials of the first seal, the second seal and the third seal are elastic insulation materials which meet the food safety standards, preferably: silica gel.

3) For the atomizer core, materials for the first shell and the first electrode are metals with sufficient electrical conductivity, preferably: stainless steel and chrome-plated brass; a material of the slow penetration unit is a material with a multi-porous or a multi-fiber structure, which is safe for food, preferred: micro-porous ceramic, foam ceramic, natural fiber, man-made fiber, etc.; a material of the first insulation seal is an elastic insulation material which meet the food safety standards, preferably: silica gel; a material of the heater is an eco-friendly material with a high electricity-heat exchange rate and a high melting point, preferably: Ni—Cr alloy, Fe—Cr—Al alloy, Cr—Al—Co alloy, nickel 200, and titanium alloy.

4) For the electronic cigarette flavoring liquid tank: materials of the top supporter, the side hole tube, the bottom supporter, and the second electrode are metals with sufficient electrical conductivity, preferably: stainless steel and chrome-plated brass; a material of the transparent unit is a transparent material which meet the food safety standards, preferably: glass, plastic, etc.; materials of the fourth seal, the fifth seal and the second insulation seal are elastic insulation materials which meet the food safety standards, preferably: silica gel.

5) For the power and control unit: materials of the second top supporter and the third electrode are metals with sufficient electrical conductivity, preferably: stainless steel and chrome-plated brass; a material of the thin-walled tube is a metal with sufficient electrical conductivity, preferably: stainless steel and chrome-plated brass; the battery is preferably a rechargeable lithium ion battery, nickel metal hydride battery, nickel cadmium battery, lithium iron phosphate battery, etc.; a material of the third insulation seal is an eco-friendly elastic insulating material, preferably: silica gel and rubber; a material of the power switch is a plastic or metal material produced by injection molding, die casting, machining, etc.

Principles of the present invention are as follows:

1) A working current loop of the present invention is as follows:

after assembling, the first electrode electrically contacts with the second electrode and the third electrode in sequence in a stable and effective form; and the first shell electrically contacts with the second shell and the third shell in sequence in a stable and effective form.

When the power switch of the power and control unit is turned on, the battery begins to supply electricity. The first pole of the battery is connected to the first pole of the heater of the atomizer core through the third electrode, the second electrode and the first electrode. The second pole of the battery is connected to the second pole of the heater through the thin-walled tube of the third shell, the second top supporter, the second shell and the first shell, for forming the complete current loop.

(1) When the first bottom supporter of the second shell directly contacts with the first shell, a current from the thin-walled tube and the second top supporter of the third shell is directly sent to the first shell through the first bottom supporter of the second shell, and finally reaches the second pole of the heater.

(2) When the first bottom supporter of the second shell does not contact with the first shell, a current is not able to be directed transmitted between the first shell and second shell, which means the current needs to pass through the top unit: wherein the current form the thin-walled tube and the second top supporter of the third shell passes through the first bottom supporter of the second shell, the side hole tube and the first top supporter, the connecting supporter of the top unit, the double-layer air tunnel, and the first shell, and finally reaches the second pole of the heater.

During design, the embodiment (1) is preferred.

2) the air flow of the present invention during smoking: enters the top unit through the air inlet, passes through the air inlet tunnel, the outer air tunnel tube for going downwards and reaching the hollow part of the atomizer core; after being thoroughly mixed with the atomizing steam, the air flow turns upwards and passes through the inner air tunnel tube and the two eccentric tunnels of the mouth piece, so as to finally enter the mouth of the user.

3) the electronic cigarette flavoring liquid flow of the present invention: is firstly added to the electronic cigarette flavoring liquid tank with a proper volume, then passes through the oil inlet of the first shell for entering the slow penetration unit; when the slow penetration unit is saturated and two sides of the oil inlet are balanced, the electronic cigarette flavoring liquid stops entering the slow penetration unit until the electronic cigarette flavoring liquid is consumed by vaporizing during atomizing, then the electronic cigarette flavoring liquid flows to the slow penetration unit through the oil inlet again; when the two sides of the oil inlet are balanced again, the electronic cigarette flavoring liquid stops entering the slow penetration unit; wherein the above processes are circulated.

4) the electronic cigarette flavoring liquid of the present invention is added by that: an assembly formed by the mouth piece, the top unit, and the atomizer core is removed from the top portion of the electronic cigarette flavoring liquid tank, the electronic cigarette flavoring liquid is added into the electronic cigarette flavoring liquid tank without exceeding a max volume, then the electronic cigarette is assembled again.

Benefit effects of the present invention are as follows:

1) According to the present invention, the mouth piece has the two eccentric tunnels, wherein the cross sections of the two eccentric tunnels are tangent with each other or not intersected at all, in such a manner that the electronic cigarette flavoring liquid is prevented from being splashed into the mouth from the atomizer core, resulting in direct stimulation of the electronic cigarette flavoring liquid.

2) According to the top unit of the present invention: (1) top loop air intake and the double-layer air tunnel are adopted, wherein the top loop air intake is able to effectively prevent the electronic cigarette flavoring liquid to flow in through the air inlets, and the double-layer air tunnel is able to guide the air flow into the atomizer core through the outer air tunnel tube; after being thoroughly mixed with the atomizing steam, the air flow enters the mouth of the user through the inner air tunnel tube and the mouth piece; (2) the air inlets are hided with the decoration around, so as to be externally invisible, leading to a clearer and prettier appearance; (3) seals are provided at key parts such as the top unit, the mouth piece, the atomizer core and the electronic cigarette flavoring liquid storage, so as to avoid gas and electronic cigarette flavoring liquid leakage; (4) the air outlet slot is provided at the bottom portion of the top unit, in such a manner that when the assembly formed by the mouth piece, the top unit and the atomizer core is installed on the electronic cigarette flavoring liquid tank, air is sealed and compressed to drive the electronic cigarette flavoring liquid to enter the atomizer core.

3) According to the atomizer core of the present invention: (1) the bottom portion thereof is sealed, and the top portion thereof is opened to form the hollow structure, for ensuring that the atomizer core is able to be mounted at the bottom portion of the top unit, and be loaded in through the top portion of the electronic cigarette flavoring liquid tank; (2) the electronic cigarette flavoring liquid inlet is evenly arranged at a side face, and the electronic cigarette flavoring liquid is transmitted to the heater through the slow penetration unit; the heater closely cooperates with the slow penetration unit, in such a manner that with a proper heat and a proper electronic cigarette flavoring liquid supply, an atomizing efficiency is greatly improved, a steam amount is increased, a diameter of the steam is smaller and evener, a tasty is batter.

4) According to the electronic cigarette flavoring liquid tank of the present invention: (1) the bottom portion thereof is sealed, and the top portion thereof is opened to form the hollow structure, wherein sealing the bottom portion thereof is able to avoid electronic cigarette flavoring liquid leakage, and the hollow structure of the top portion thereof is conducive to cleaning and adding the electronic cigarette flavoring liquid; (2) the electronic cigarette flavoring liquid is observable through the hole on a side face; (3) for avoiding detaching or loosening the electronic cigarette flavoring liquid tank by mistake, the electronic cigarette flavoring liquid tank is not able to be detached or loosened by rotating any part of a circumferential surface of the external wall of the electronic cigarette flavoring liquid tank.

5) According to the power and control unit of the present invention: (1) the PCB is horizontally arranged (which is perpendicular to the axial direction of the electronic cigarette), so as to effectively reduce a total length; (2) different light combinations with different colors and twinkle frequencies are provided, wherein cross combinations thereof are corresponding to every possible error state, for clearly judging the error; (3) the breather hole is provided at the second bottom supporter of the third shell, for avoiding exploding when battery accident occurs.

6) The present invention improves an installation method of the atomizer core, wherein the atomizer core is installed at the bottom portion of the top unit, in such a manner that the atomizer core is able to be detached from the top portion of the electronic cigarette flavoring liquid tank with the top unit, which simplifies a replacing operation.

7) The present invention improves an electronic cigarette flavoring liquid filling method, wherein the electronic cigarette flavoring liquid is added from the opening at the top portion of the electronic cigarette flavoring liquid tank, which is convenient.

### BRIEF DESCRIPTION OF THE DRAWINGS

For fully illustrating preferred embodiment of the present invention, drawings have been shown and described for the purposes of illustrating. To those of the ordinary skill in the art, without creative labor, other drawings are able to be made according to the drawings below.

FIG. 1 is a side sectional view of each part in a separated state according to a preferred embodiment 1 of the present invention.

FIG. 2a is a sketch view of replacing an atomizer core according to the preferred embodiment 1 of the present invention (a side sectional sketch view).

FIG. 2b is a sketch view of adding electronic cigarette flavoring liquid according to the preferred embodiment 1 of the present invention.

FIG. 2c is a sketch view of replacing an assembly 8 or a power and control unit 5 of an electronic cigarette according to the preferred embodiment 1 of the present invention.

FIG. 2d is a sketch view of the electronic cigarette after being assembled according to the preferred embodiment 1 of the present invention.

FIG. 3a is a top sectional view of the atomizer core according to the preferred embodiment 1 of the present invention.

FIG. 3b is a side sectional view of the atomizer core according to the preferred embodiment 1 of the present invention.

FIG. 4 is a side sectional view of the assembly 8 when a shell of the atomizer core directly contacts with a bottom supporter of an electronic cigarette flavoring liquid tank according to a preferred embodiment 2 of the present invention.

FIG. 5 is a schematic view of a control circuit of the power and control unit of the present invention.

### ELEMENT REFERENCE

mouth piece 1; eccentric tunnels 11 and 12;
top unit 2; connecting supporter 21; air outlet slot 211; air inlet tunnel 212; decoration 22;
air inlet 23; decoration 24; inner air tunnel tube 25; first seal 26a, second seal 26b, third seal 26c; outer air tunnel tube 27; connector 28;
atomizer core 3; first shell 31; oil inlet 311; slow penetration unit 32; first insulating seal 33; heater 34; first electrode 35;
electronic cigarette flavoring liquid tank 4; first top supporter 41; side hole tube 42; hole 421; transparent unit 43; first bottom supporter 44; second electrode 45; fourth seal 46a, fifth seal 46b; second insulating seal 47;
power and control unit 5; second top supporter 51; control circuit 52; thin-walled tube 53; USB interface 531; battery 54; third insulation seal 55; third electrode 56; power switch 57; second bottom supporter 58; breather hole 581;
assembly 6 formed by connecting the mouth piece 1 and the top unit 2;
assembly 7 formed by connecting the mouth piece 1, the top unit 2, and the atomizer core 3;
assembly 8 formed by connecting the mouth piece 1, the top unit 2, the atomizer core 3, and the electronic cigarette flavoring liquid tank 4;
assembly 9 formed by connecting the electronic cigarette flavoring liquid tank 4, and the power and control unit 5;
overall assembly 10 formed by connecting the mouth piece 1, the top unit 2, the atomizer core 3, the electronic cigarette flavoring liquid tank 4, the electronic cigarette flavoring liquid tank 4, and the power and control unit 5.

### DETAILED DESCRIPTION OF THE PREFERRED EMBODIMENT

Referring to drawings and preferred embodiments, the present invention is further illustrated.

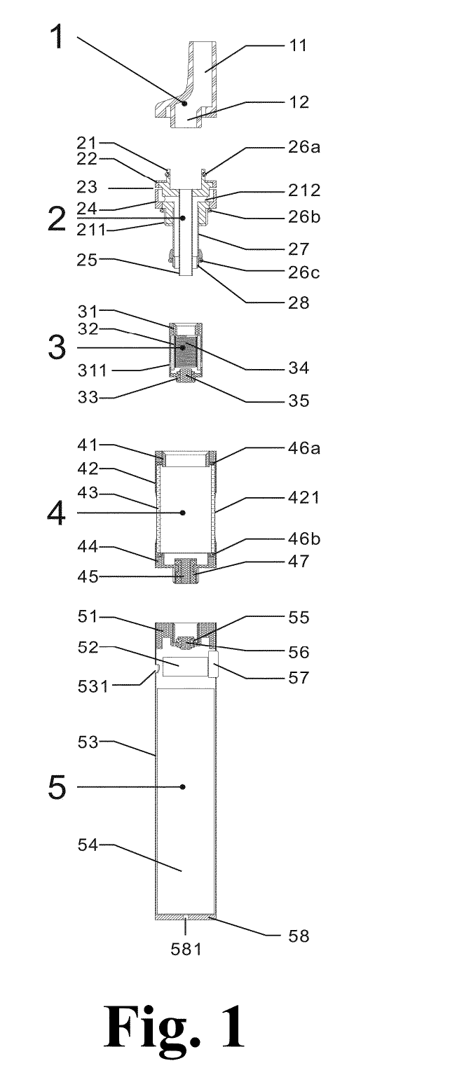

Referring to FIG. 1, an electronic cigarette of a preferred embodiment 1 comprises a mouth piece 1 which is detachable, a top unit 2, an atomizer core 3, an electronic cigarette flavoring liquid tank 4 and a power and control unit 5 in sequence from a top to a bottom, wherein:

According to the preferred embodiment 1, two eccentric tunnels, which are an eccentric tunnel 11 and an eccentric tunnel 12, are provided inside the mouth piece 1, and communicate with each other in a roundabout form; cross sections of the two eccentric tunnels are tangent with each other or not intersected at all.

The mouth piece 1 is provided at a top portion of the electronic cigarette, a material thereof is a metal meets the food safety standards.

Referring to FIG. 1, the top unit 2 comprises a connecting supporter 21 at the top portion thereof, an air inlet tunnel 212 is provided inside the connecting supporter 21; a decoration 24 is externally provided on the connecting supporter 21, which surrounds the air inlet tunnel 212 and keeps a plurality of the air inlets 23 which are arranged in a 360 loop form; the air inlets 23 are connected to the air inlet tunnel 212, and an air outlet slot 211 is provided at a bottom portion of the connecting supporter 21; wherein when an assembly 7 is installed to the electronic cigarette flavoring liquid tank 4, gas is discharged along the air outlet slot 211; if no air outlet slot 211 is provided, the gas will be sealed and compressed during assembling, and enter the atomizer core 3.

The top unit 2 further comprises a decoration 22. A double-layer air tunnel is provided inside the top unit 2, comprising an outer air tunnel tube 27 and an inner air tunnel tube 25. With the top unit 2, the air flow passes through the loop air inlets 27, the air inlet tunnel 212 and the outer air tunnel tube 27 in sequence, so as to enter a hollow portion of the atomizer core 3; after being thoroughly mixed with the atomizing steam, the air flow turns upwards and passes through the inner air tunnel tube 25 and the eccentric tunnels 11 and 12 of the mouth piece 1 in sequence, so as to finally enter the mouth of the user.

A first seal 26a is provided at an external wall of the top unit 2 where the mouth piece 1 is mounted, a connector 28 is provided at an assembling position of the top unit 2 and the atomizer core 3, so does a second seal 26b; and a third seal 26c is provided at an assembling position of the top unit 2 and the electronic cigarette flavoring liquid tank 4; wherein the seals are able to effectively avoiding gas and electronic cigarette flavoring liquid leakage.

Materials of the connecting supporter 21 and the connector 28 are chrome-plated brass with sufficient electrical conductivity; materials of the decorations 22 and 24 are eco-friendly stainless steel; materials of the inner air tunnel tube 25 and the outer air tunnel tube 27 are eco-friendly hollow thin-walled chrome-plated brass pipes; materials of the first seal 26a, the second seal 26b and the third seal 26c are elastic insulation silica gel which meet food safety standards.

The top portion of the top unit 2 is connected to the mouth piece 1 through a screw thread, and the bottom portion of the top unit 2 is connected to the atomizer core 3 through a screw thread.

Referring to FIG. 1, according to the atomizer core 3 of the preferred embodiment 1, the bottom portion thereof is sealed, and the top portion thereof has the hollow structure, for ensuring that the atomizer core 3 is able to be mounted at the bottom portion of the top unit 2, and be loaded in through the top portion of the electronic cigarette flavoring liquid tank 4. The atomizer core 3 comprises a first shell 31, wherein a heater 34 is provided inside the first shell 31; a slow penetration unit 32 is closely pressed against an internal wall of the first shell 31; an electronic cigarette flavoring liquid inlet 311, which allows electronic cigarette flavoring liquid in the electronic cigarette flavoring liquid tank 4 to enter the slow penetration unit 32, is provided on the first shell 31; a first electrode 35 is provided at a bottom portion of the first shell 31, and a first insulating seal 33 is provided between the first shell 31 and the first electrode 35; the bottom portion of the first shell 31 is sealed through shrink fit of the first insulating seal 33, the first shell 31 and the first electrode 35; a first pole of the heater 34 is electrically contacted with the first electrode 35, and a second pole of the heater 34 is electrically contacted with the first shell 31.

For the atomizer core, materials for the first shell 31 and the first electrode 35 are chrome-plated brass with sufficient electrical conductivity; a material of the slow penetration unit 32 is micro-porous ceramic with a multi-porous structure, which meets the food safety standards; a material of the first insulating seal 33 is an elastic insulation silica gel 3 which meets the food safety standards; a material of the heater 34 is an eco-friendly Ni—Cr alloy with a high electricity-heat exchange rate and a high melting point.

Referring to FIG. 1, the electronic cigarette flavoring liquid tank 4 has a hollow structure with a sealed bottom and an opened top, and is connected to the bottom portion of the top unit 2 through a screw thread. The electronic cigarette flavoring liquid tank 4 comprises a second shell, wherein the second shell comprises a first top supporter 41, a side hole tube 42, and a first bottom supporter 44, wherein the first top supporter 41 has a hollow structure having an opened top, and is connected to the first bottom supporter 44 through the side hole tube 42; a second electrode 45 is provided at a bottom portion of the first bottom supporter 44; the second electrode 45 compresses a second insulating seal 47, for provide shrink fit with the first bottom supporter 44; a hole 421 is drilled on the side hole tube 42 for observing an electronic cigarette flavoring liquid content; the electronic cigarette flavoring liquid tank 4 further comprises a transparent unit 43, wherein the transparent unit is mounted at a middle of the side hole tube 42 by a fourth seal 46a at a top face thereof and a fifth seal 46b at a bottom face thereof with an elastic effect.

For the electronic cigarette flavoring liquid tank 4: materials of the top supporter 41, the side hole tube 42, the bottom supporter 44, and the second electrode 45 are chrome-plated brass with sufficient electrical conductivity; a material of the transparent unit 43 is a transparent glass which is safe for food; materials of the fourth seal 46a, the fifth seal 46b and the second insulation seal 47 are elastic insulation silica gel which meets the food safety standards.

An inner diameter of the side hole tube 42 is larger than an outer diameter of transparent unit 43, and the transparent unit 43 is cased by the side hole tube 42. A volume of the electronic cigarette flavoring liquid tank 4 is 0.5-20 mL, an inner diameter of the top supporter 41 is no less than 8 mm.

Referring to FIG. 1, according to the preferred embodiment 1, the power and control unit 5 comprises a third shell, wherein the third shell comprises a second top supporter 51, a thin-walled tube 53, and a second bottom supporter 58, wherein the second top supporter 51 is connected to the second bottom supporter 58 through the thin-walled tube 53; a third electrode 56 is provided at an opening of the top supporter 51, which compresses a third insulating seal 55 for providing shrink fit with the second top supporter 51; a breather hole 581 is provided on the second bottom supporter 58; the power and control unit 5 further comprises a control circuit 52, a battery 54, a power switch 57 and an USB interface 531, wherein the USB interface is for charging and data transmitting. The control circuit 52 is a single-layer PCB or a multi-layer PCB, the PCB is horizontally arranged, which is perpendicular to an axial direction of the electronic cigarette; after receiving a trigger signal from the power switch 57, the control circuit 52 outputs or cuts off a current.

For the power and control unit 5: materials of the second top supporter 51 and the third electrode 56 are chrome-plated brass with sufficient electrical conductivity; a material of the thin-walled tube 53 is chrome-plated brass with sufficient electrical conductivity; the battery 54 is a rechargeable lithium ion battery; a material of the third insulation seal 55 is eco-friendly elastic insulating silica gel; a material of the power switch 57 is plastic.

According to the preferred embodiment 1, the control circuit 52 of the power and control unit 5 is connected to an LED light tube, wherein by setting light tips with different colors and twinkle frequencies for the control circuit 52, different light combinations are respectively corresponding to a short circuit alarm, a low resistance protection alarm, an open circuit alarm, a low voltage alarm, a working overtime alarm, an overheat protection alarm, and a battery overload alarm, in such a manner that the user clearly judges an error condition. Settings of the preferred embodiment 1 are as follows:

(1) short circuit alarm: red LED with single-flash for 10 times (wherein frequency is 3 Hz);

(2) low resistance protection alarm: white LED with double-flash for 5 times (wherein frequency is 3 Hz, interval is 1 Hz);

(3) open circuit alarm: white LED with flash for 10 times (wherein frequency is 3 Hz);

(4) a low voltage alarm: red LED and white LED with alternative flash for 5 times (wherein frequency is 3 Hz);

(5) working overtime alarm: white LED with triple-flash for 5 times (wherein frequency is 3 Hz, interval is 1 Hz);

(6) overheat protection alarm and battery overload alarm: red LED with double flash for 5 times (wherein frequency is 3 Hz, interval is 1 Hz).

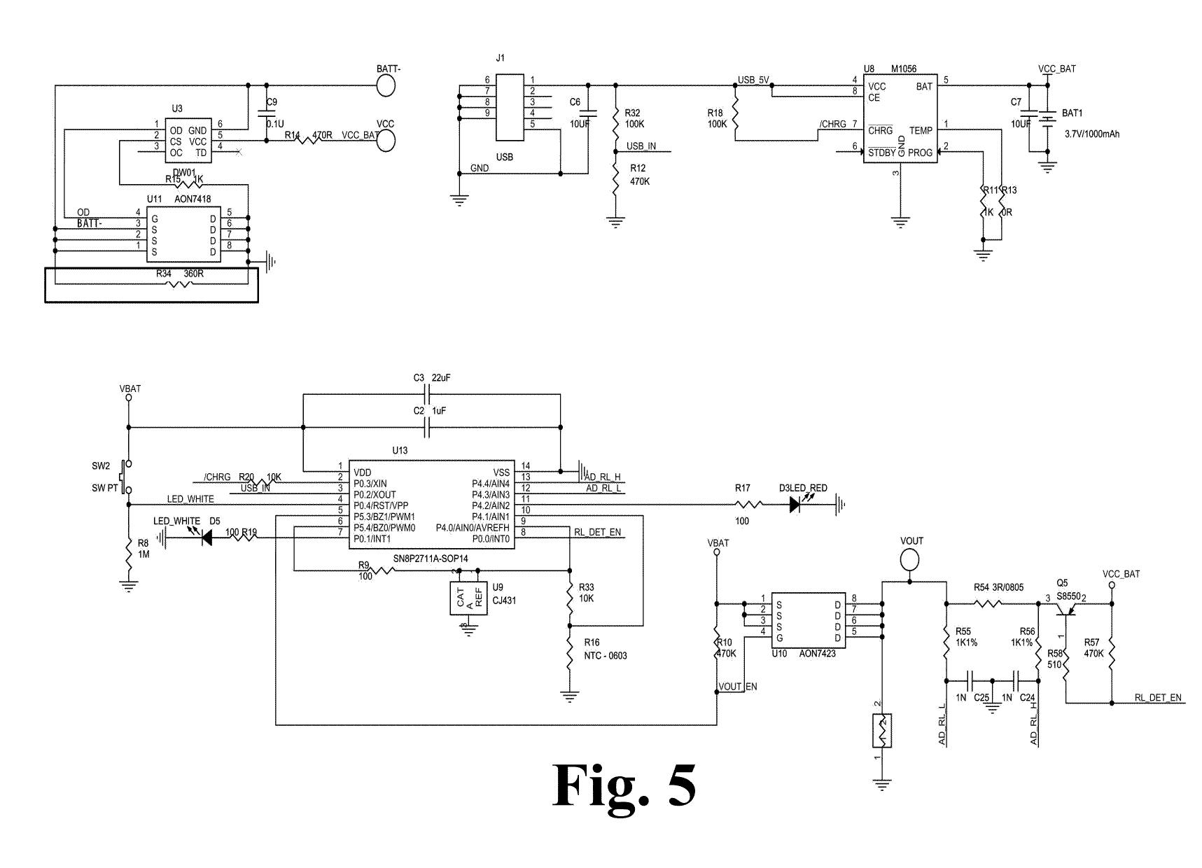

The control circuit 52 according to the preferred embodiment 1 is shown in FIG. 5.

A working current loop of the preferred embodiment 1 is as follows:

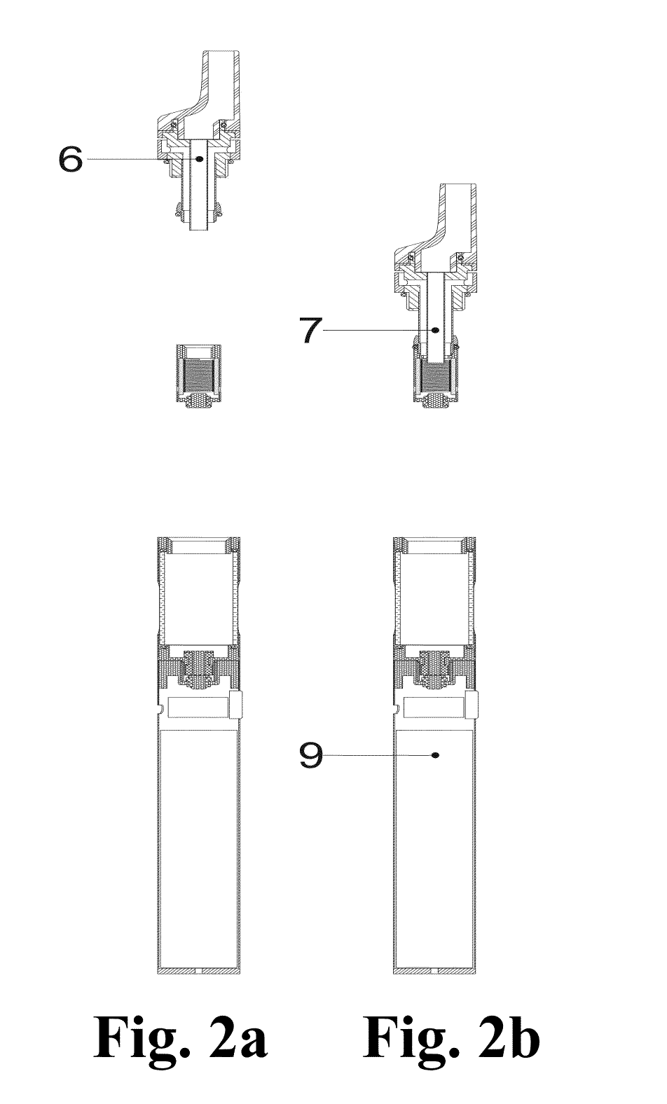

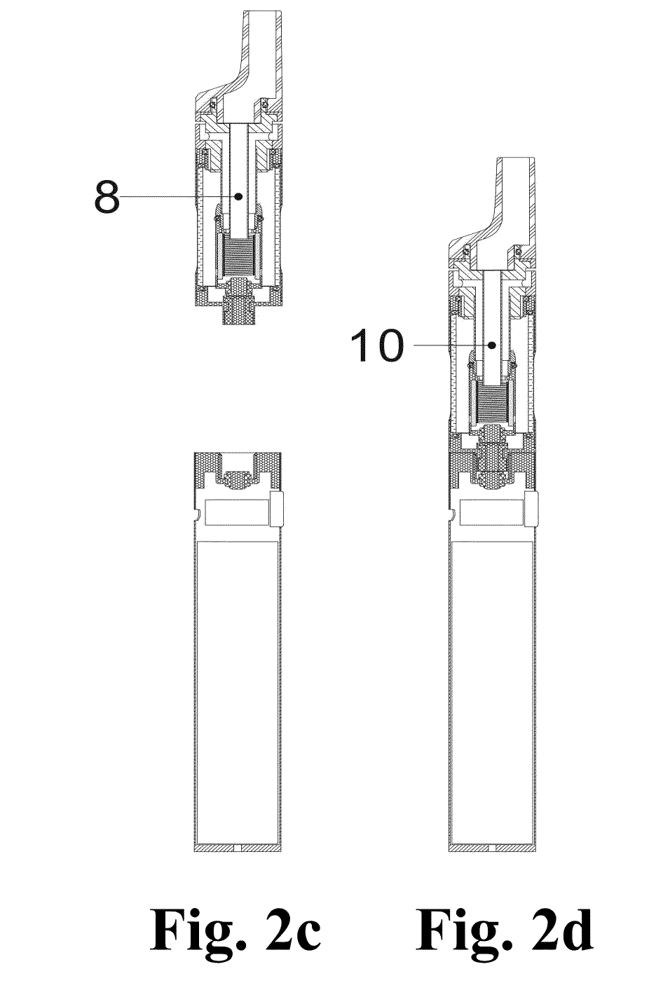

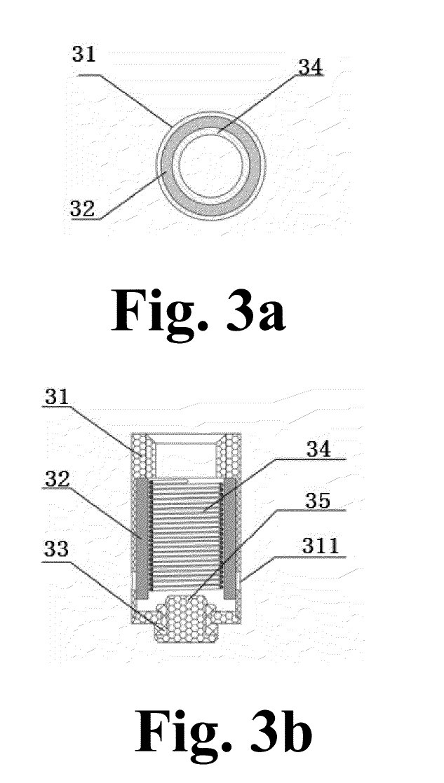

Referring to FIG. 2d, after assembling, the first electrode 35 at the bottom portion of the atomizer core 3 electrically contacts with the second electrode 45 and the third electrode 56 in sequence in a stable and effective form. At the moment, the inner diameter of the first bottom supporter 44 is larger than the outer diameter of the first shell, and the first bottom supporter of the second shell does not contact with the first shell. Therefore, for communicating the first shell 31 and the second shell, the current needs to pass through the first bottom supporter 44 of the second shell, the side hole tube 42, the first top supporter 47, and the top unit 2. A specific power loop is as follows:

when the power switch 57 of the power and control unit 5 is turned on, the battery 54 begins to supply electricity. The first pole of the battery 54 is connected to the first pole of the heater 34 of the atomizer core 3 through the third electrode 56, the second electrode 45 and the first electrode 35; the second pole of the battery 54 is connected to the second pole of the heater 34 of the atomizer core 3 through the thin-walled tube 53 of the third shell, the second top supporter 51, the first bottom supporter 44 of the second shell, the side hole tube 42, the first top supporter 47, the connecting supporter 21 of the top unit 2, the outer air tunnel tube 27, the inner air tunnel tube 25, and the first shell 31, for forming the complete current loop.

The electronic cigarette flavoring liquid of the preferred embodiment 1: is firstly added to the electronic cigarette flavoring liquid tank 4 with a proper volume, then passes through the electronic cigarette flavoring liquid inlet 311 of the first shell 31 for entering the slow penetration unit 32; when the slow penetration unit 32 is saturated and two sides of the electronic cigarette flavoring liquid inlet 311 are balanced, the electronic cigarette flavoring liquid stops entering the slow penetration unit 32 until the electronic cigarette flavoring liquid is consumed by vaporizing during atomizing, then the electronic cigarette flavoring liquid flows to the slow penetration unit 32 through the electronic cigarette flavoring liquid inlet 311 again; when the two sides of the electronic cigarette flavoring liquid inlet 311 are balanced again, the electronic cigarette flavoring liquid stops entering the slow penetration unit 32; wherein the above processes are circulated.

According to the preferred embodiment 1, an assembly 6 is formed by connecting the mouth piece 1 and the top unit 2; an assembly 7 is formed by connecting the mouth piece 1, the top unit 2, and the atomizer core 3; an assembly 8 is formed by connecting the mouth piece 1, the top unit 2, the atomizer core 3, and the electronic cigarette flavoring liquid tank 4; an assembly 9 is formed by connecting the electronic cigarette flavoring liquid tank 4, and the power and control unit 5; and an overall assembly 10 formed by connecting the mouth piece 1, the top unit 2, the atomizer core 3, the electronic cigarette flavoring liquid tank 4, the electronic cigarette flavoring liquid tank 4, and the power and control unit 5.

Referring to FIG. 2a, for replacing the atomizer core 3, the assembly 6 is firstly detached from the top portion of the electronic cigarette flavoring liquid tank 4, then the atomizer core 3 is removed from the top portion of the electronic cigarette flavoring liquid tank 4.

Referring to FIG. 2b, for adding the electronic cigarette flavoring liquid, the assembly 8 is firstly detached from the top portion of the power and control unit 5, then the assembly 7 is detached from the top portion of the electronic cigarette flavoring liquid tank 4, and electronic cigarette flavoring liquid is added into the electronic cigarette flavoring liquid tank 4 without exceeding a maximal volume, finally the electronic cigarette is assembled again.

Referring to FIG. 2c, for filling the electronic cigarette flavoring liquid, the assembly 7 is directly detached from a top portion of the assembly 9, and electronic cigarette flavoring liquid is added into the electronic cigarette flavoring liquid tank 4 without exceeding a maximal volume, finally the electronic cigarette is assembled again.

FIG. 2d illustrates the overall assembly 10 of the electronic cigarette after assembling.

1) According to the preferred embodiment 1, the mouth piece has the two eccentric tunnels 11 and 12, wherein the cross sections of the two eccentric tunnels 11 and 12 are tangent with each other or not intersected at all, in such a manner that the electronic cigarette flavoring liquid is prevented from being splashed into the mouth from the atomizer core 3, resulting in direct stimulation of the electronic cigarette flavoring liquid.

According to the top unit 2 of the preferred embodiment 1: (1) top loop air intake and the double-layer air tunnel are adopted, wherein the top loop air intake is able to effectively prevent the electronic cigarette flavoring liquid to flow in through the air inlets, and the double-layer air tunnel is able to guide the air flow into the atomizer core 3 through the outer air tunnel tube 27; after being thoroughly mixed with the atomizing steam, the air flow enters the mouth of the user through the inner air tunnel tube 25 and the mouth piece 1; (2) the air inlets are hided with the decoration 24 around, so as to be externally invisible, leading to a clearer and prettier appearance; (3) seals are provided at key parts such as the top unit 2, the mouth piece 1, the atomizer core 3 and the electronic cigarette flavoring liquid tank 4, so as to avoid gas and electronic cigarette flavoring liquid leakage.

According to the atomizer core 3 of the preferred embodiment 1: (1) the bottom portion thereof is sealed, and the top portion thereof is opened to form the hollow structure; (2) the electronic cigarette flavoring liquid inlet 311 is evenly arranged at the shell, and the electronic cigarette flavoring liquid is transmitted to the heater 34 through the slow penetration unit 32; the heater 34 closely cooperates with the slow penetration unit 32, in such a manner that with a proper heat and a proper electronic cigarette flavoring liquid supply, an atomizing efficiency is greatly improved, a steam amount is increased, a diameter of the steam is smaller and evener, a taste is batter.

According to the electronic cigarette flavoring liquid tank 4 of the preferred embodiment 1: (1) the bottom portion thereof is sealed, and the top portion thereof is opened to form the hollow structure, wherein sealing the bottom portion thereof is able to avoid electronic cigarette flavoring liquid leakage, and the hollow structure of the top portion thereof is conducive to cleaning and adding the electronic cigarette flavoring liquid; (2) the electronic cigarette flavoring liquid is observable through the hole 421 on a side face; (3) for avoiding detaching or loosening the electronic cigarette flavoring liquid tank 4 by mistake, the electronic cigarette flavoring liquid tank 4 is not able to be detached or loosened by rotating any part of a circumferential surface of the external wall of the electronic cigarette flavoring liquid tank.

According to the power and control unit 5 of the preferred embodiment 1: (1) the PCB is horizontally arranged (which is perpendicular to the axial direction of the electronic cigarette), so as to effectively reduce a total length; (2) different light combinations with different colors and twinkle frequencies are provided, wherein cross combinations thereof are corresponding to every possible error state, for clearly judging the error; (3) the breather hole is provided at the second bottom supporter of the third shell, for avoiding exploding when battery accident occurs.

The preferred embodiment 1 improves an installation method of the atomizer core 3, wherein the atomizer core 3 is installed at the bottom portion of the top unit 2, in such a manner that the atomizer core 3 is able to be detached from the top portion of the electronic cigarette flavoring liquid tank 4 with the top unit 2, which simplifies a replacing operation.

The preferred embodiment 1 improves an electronic cigarette flavoring liquid adding method, wherein the electronic cigarette flavoring liquid is added from the opening at the top portion of the electronic cigarette flavoring liquid tank 4, and the inner diameter thereof is more than 8 mm, which is convenient.

### Preferred Embodiment 2

Compared with the preferred embodiment 1, differences of the preferred embodiment 2 are as follows.

For the mouth piece 1, a material thereof is ceramics which meets the food safety standards.

For the top unit 2: materials of the connecting supporter 21 and the connector 28 are stainless steel with sufficient electrical conductivity; materials of the decorations 22 and 24 are eco-friendly chrome-plated brass; materials of the inner air tunnel tube 25 and the outer air tunnel tube 27 are eco-friendly hollow thin-walled stainless steel pipes.

For the atomizer core 3, a material of the slow penetration unit 4 is man-made fiber with a multi-fiber structure, which meets the food safety standards; a material of the heater 34 is an eco-friendly titanium alloy with a high electricity-heat exchange rate and a high melting point.

For the electronic cigarette flavoring liquid storage 4: materials of the top supporter 41, the side hole tube 42, the bottom supporter 44, and the second electrode 45 are stainless steel with sufficient electrical conductivity; a material of the transparent unit 43 is transparent plastic which meets the food safety standards.

The inner diameter of the side hole tube 42 of the electronic cigarette flavoring liquid tank 4 is smaller than the outer diameter of the transparent unit 43, the side hole tube 42 is cased by the transparent unit 43.

For the power and control unit 5: materials of the second top supporter 51 and the third electrode 56 are stainless steel with sufficient electrical conductivity; a material of the thin-walled tube 53 is stainless steel with sufficient electrical conductivity; the battery 54 is preferably a rechargeable lithium ion battery, nickel metal hydride battery, nickel cadmium battery, lithium iron phosphate battery, etc.; a material of the third insulation seal 55 is eco-friendly elastic insulating rubber.

Through clips, the top unit 2 is connected to the mouth piece 1, the top unit 2 is connected to the atomizer core 3, the top unit 2 is connected the electronic cigarette flavoring liquid tank 4, and the electronic cigarette flavoring liquid tank 4 is connected to the power and control unit 5.

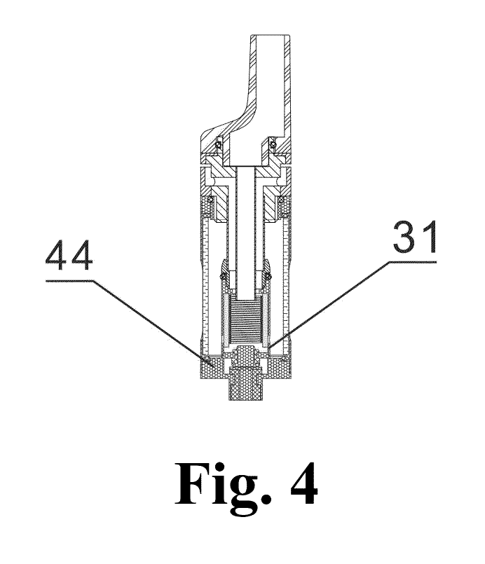

Referring to FIG. 4, during design of the preferred embodiment 2, the inner diameter of the first bottom supporter 44 of the electronic cigarette flavoring liquid tank 4 is smaller than the outer diameter of the first shell 31. As a result, the first bottom supporter 44 of the second shell directly contacts with the first shell 31. Therefore, the first shell 31 directly contacts with the second shell, wherein a working current loop of the preferred embodiment 2 is as follows:

when the power switch 57 of the power and control unit 5 is turned on, the battery 54 begins to supply electricity. The first pole of the battery 54 is connected to the first pole of the heater 34 of the atomizer core 3 through the third electrode 56, the second electrode 45 and the first electrode 35; the second pole of the battery 54 is connected to the second pole of the heater 34 of the atomizer core 3 through the thin-walled tube 53 of the third shell, the second top supporter 51, the first bottom supporter 44 of the second shell, and the first shell 31, for forming the complete current loop.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An electronic cigarette, wherein:
from a top to a bottom, the electronic cigarette comprises a mouth piece which is detachable, a top unit, an atomizer core, an electronic cigarette flavoring liquid tank and a power and control unit in sequence, wherein
a bottom portion of the mouth piece is detachably connected to a top portion of the top unit;
the top unit is connected to the mouth piece and the atomizer core, and has air inlets; wherein after entering the atomizer core through the air inlets, air flow is thoroughly mixed with atomizing steam in the atomizer core, then the air flow passes through the top unit, the mouth piece, and finally enters a mouth of a user;
the atomizer core comprises a first shell; a slow penetration unit is closely pressed against an internal wall of the first shell; an electronic cigarette flavoring liquid inlet, which allows electronic cigarette flavoring liquid in the electronic cigarette flavoring liquid tank to enter the slow penetration unit, is provided on the first shell, and a heater is closely pressed against the slow penetration unit; a first electrode is provided at a bottom portion of the first shell, and a first insulating seal is provided between the first shell and the first electrode; a first pole of the heater is electrically contacted with the first electrode, a second pole of the heater is electrically contacted with the first shell; the bottom portion of the first shell is sealed through shrink fit of the first insulating seal, the first shell and the first electrode; a top portion of the first shell is opened, so as to form a hollow structure having a sealed bottom and an opened top; the atomizer core is loaded in from a top portion of the electronic cigarette flavoring liquid tank, and a top portion of the atomizer core is detachably connected to a bottom portion of the top unit;
the electronic cigarette flavoring liquid tank comprises a second shell and a second electrode provided at a bottom portion of the second shell, wherein a second insulating seal is provided between the second shell and the second electrode, the bottom portion of the second shell is sealed through shrink fit of the second insulation seal, the second shell and the second electrode; a top portion of the second shell is opened, so as to form a hollow structure of the electronic cigarette flavoring liquid tank, which has a sealed bottom and an opened top; the electronic cigarette flavoring liquid tank is detachably connected to a top portion of the power and control unit;
the power and control unit comprises a third shell and a third electrode provided at a top portion of the third shell, wherein a third insulating seal is provided between the third shell and the third electrode, for insulation sealing therebetween; a battery inside the power and control unit supplies the electronic cigarette, and outputs or cuts off a current through a power switch;
after assembling, the first pole of the heater of the atomizer core is connected to a first pole of the battery inside the power and control unit through the first electrode, the second electrode and the third electrode in sequence; the second pole of the heater of the atomizer core is connected to a second pole of the battery inside the power and control unit through the first shell, the second shell and the third shell in sequence; complete current loops are formed at each part; the heater of the atomizer core is supplied by the power and control unit for atomizing the electronic cigarette flavoring liquid.

2. The electronic cigarette, as recited in claim 1, wherein
two eccentric tunnels are provided inside the mouth piece, and communicate with each other in a roundabout form; cross sections of the two eccentric tunnels are tangent with each other or not intersected at all.

3. The electronic cigarette, as recited in claim 1, wherein
the top unit comprises a connecting supporter at the top portion thereof, an air inlet tunnel is provided inside the connecting supporter; a decoration is externally provided on the connecting supporter, which surrounds the air inlet tunnel and keeps a plurality of the air inlets, the air inlets are arranged in a 360 loop form, for loop air intake; the air inlets are connected to the air inlet tunnel, and an air outlet slot is provided at a bottom portion of the connecting supporter;
the top unit further comprises a first seal provided at an external wall of the top unit where the mouth piece is mounted, a second seal provided at an assembling position of the top unit and the atomizer core, and a third seal provided at an assembling position of the top unit and the electronic cigarette flavoring liquid tank;
a connector is provided at the assembling position of the top unit and the atomizer core.

4. The electronic cigarette, as recited in claim 2, wherein
the top unit comprises a connecting supporter at the top portion thereof, an air inlet tunnel is provided inside the connecting supporter; a decoration is externally provided on the connecting supporter, which surrounds the air inlet tunnel and keeps a plurality of the air inlets, the air inlets are arranged in a 360 loop form, for loop air intake; the air inlets are connected to the air inlet tunnel, and an air outlet slot is provided at a bottom portion of the connecting supporter;
the top unit further comprises a first seal provided at an external wall of the top unit where the mouth piece is mounted, a second seal provided at an assembling position of the top unit and the atomizer core, and a third seal provided at an assembling position of the top unit and the electronic cigarette flavoring liquid tank;
a connector is provided at the assembling position of the top unit and the atomizer core.

5. The electronic cigarette, as recited in claim 3, wherein
a double-layer air tunnel is provided inside the top unit, comprising an inner air tunnel tube and an outer air tunnel tube;
with the top unit, the air flow passes through the air inlet, the air inlet tunnel and the outer air tunnel tube in sequence, so as to enter a hollow portion of the atomizer core; after being thoroughly mixed with the atomizing steam, the air flow turns upwards and passes through the inner air tunnel tube and the mouth piece in sequence, so as to finally enter the mouth of the user.

6. The electronic cigarette, as recited in claim 4, wherein
a double-layer air tunnel is provided inside the top unit, comprising an inner air tunnel tube and an outer air tunnel tube;
with the top unit, the air flow passes through the air inlet, the air inlet tunnel and the outer air tunnel tube in sequence, so as to enter a hollow portion of the atomizer core; after being thoroughly mixed with the atomizing steam, the air flow turns upwards and passes through the inner air tunnel tube and the mouth piece in sequence, so as to finally enter the mouth of the user.

7. The electronic cigarette, as recited in claim 1, wherein
the second shell comprises a first top supporter, a side hole tube, and a first bottom supporter, wherein the first top supporter has a hollow structure having an opened top, and is connected to the first bottom supporter through the side hole tube; the second electrode is provided at a bottom portion of the first bottom supporter; the second electrode compresses the second insulating seal, for provide shrink fit with the first bottom supporter;
an inner diameter of the first bottom supporter is no more than an outer diameter of the first shell of the atomizer core, or the inner diameter of the first bottom supporter is larger than the outer diameter of the first shell of the atomizer core;
a hole is drilled on the side hole tube for observing an electronic cigarette flavoring liquid content; the electronic cigarette flavoring liquid tank further comprises a transparent unit, wherein the transparent unit is mounted at a middle of the side hole tube by a fourth seal at a top face thereof and a fifth seal at a bottom face thereof with an elastic effect;
the first top supporter, the side hole tube and the first bottom supporter are all electrically conductive.

8. The electronic cigarette, as recited in claim 6, wherein
the second shell comprises a first top supporter, a side hole tube, and a first bottom supporter, wherein the first top supporter has a hollow structure having an opened top, and is connected to the first bottom supporter through the side hole tube; the second electrode is provided at a bottom portion of the first bottom supporter; the second electrode compresses the second insulating seal, for provide shrink fit with the first bottom supporter;
an inner diameter of the first bottom supporter is no more than an outer diameter of the first shell of the atomizer core, or the inner diameter of the first bottom supporter is larger than the outer diameter of the first shell of the atomizer core;
a hole is drilled on the side hole tube for observing an electronic cigarette flavoring liquid content; the electronic cigarette flavoring liquid tank further comprises a transparent unit, wherein the transparent unit is mounted at a middle of the side hole tube by a fourth seal at a top face thereof and a fifth seal at a bottom face thereof with an elastic effect;
the first top supporter, the side hole tube and the first bottom supporter are all electrically conductive.

9. The electronic cigarette, as recited in claim 7, wherein
when an inner diameter of the side hole tube is larger than an outer diameter of transparent unit, the transparent unit is cased by the side hole tube; when the inner diameter of the side hole tube is smaller than the outer diameter of the transparent unit, the side hole tube is cased by the transparent unit.

10. The electronic cigarette, as recited in claim 8, wherein
when an inner diameter of the side hole tube is larger than an outer diameter of transparent unit, the transparent unit is cased by the side hole tube; when the inner diameter of the side hole tube is smaller than the outer diameter of the transparent unit, the side hole tube is cased by the transparent unit.

11. The electronic cigarette, as recited in claim 1, wherein
the third shell comprises a second top supporter, a thin-walled tube, and a second bottom supporter, wherein the second top supporter is connected to the second bottom supporter through the thin-walled tube; the third electrode is provided at an opening of the top supporter; the third insulation seal is provided between the third shell and the third electrode for insulation thereof; and a breather hole is provided on the second bottom supporter;
the power and control unit further comprises a control circuit, the battery, the power switch and an USB (universal serial bus) interface; wherein after receiving a trigger signal from the power switch, the control circuit outputs or cuts off the current.

12. The electronic cigarette, as recited in claim 10, wherein
the third shell comprises a second top supporter, a thin-walled tube, and a second bottom supporter, wherein the second top supporter is connected to the second bottom supporter through the thin-walled tube; the third electrode is provided at an opening of the top supporter; the third insulating seal is provided between the third shell and the third electrode for insulation thereof; and a breather hole is provided on the second bottom supporter;
the power and control unit further comprises a control circuit, the battery, the power switch and an USB (universal serial bus) interface; wherein after receiving a trigger signal from the power switch, the control circuit outputs or cuts off the current.

13. The electronic cigarette, as recited in claim 11, wherein
the control circuit is a single-layer PCB (printed circuit board) or a multi-layer PCB, the control circuit is horizontally arranged, which is perpendicular to an axial direction of the electronic cigarette.

14. The electronic cigarette, as recited in claim 12, wherein
the control circuit is a single-layer PCB (printed circuit board) or a multi-layer PCB, the control circuit is horizontally arranged, which is perpendicular to an axial direction of the electronic cigarette.

15. The electronic cigarette, as recited in claim 13, wherein
the control circuit is connected to a light tube, wherein by setting light tips with different colors and twinkle frequencies, different light combinations are respectively corresponding to a short circuit alarm, a low resistance protection alarm, an open circuit alarm, a low voltage alarm, a working overtime alarm, an overheat protection alarm, and a battery overload alarm, in such a manner that the user clearly judges an error condition.

16. The electronic cigarette, as recited in claim 14, wherein
the control circuit is connected to a light tube, wherein by setting light tips with different colors and twinkle frequencies, different light combinations are respectively corresponding to a short circuit alarm, a low resistance protection alarm, an open circuit alarm, a low voltage alarm, a working overtime alarm, an overheat protection alarm, and a battery overload alarm, in such a manner that the user clearly judges an error condition.

17. The electronic cigarette, as recited in claim 1, wherein
through screw threads, clips, or tight fits, the top portion of the top unit is detachably connected to the mouth piece, the bottom portion of the top unit is detachably connected to the atomizer core, the top unit is detachably connected the top portion of the electronic cigarette flavoring liquid tank, and the electronic cigarette flavoring liquid tank is detachably connected to the top portion of the power and control unit;
an individual assembly formed by the suction nozzle, the top unit, the atomizer core and the electronic cigarette flavoring liquid tank, and the individual power and control unit are two essential replaceable units of the electronic cigarette.

18. The electronic cigarette, as recited in claim 16, wherein
through screw threads, clips, or tight fits, the top portion of the top unit is detachably connected to the mouth piece, the bottom portion of the top unit is detachably connected to the atomizer core, the top unit is detachably connected the top portion of the electronic cigarette flavoring liquid tank, and the electronic cigarette flavoring liquid tank is detachably connected to the top portion of the power and control unit;
an individual assembly formed by the suction nozzle, the top unit, the atomizer core and the electronic cigarette flavoring liquid tank, and the individual power and control unit are two essential replaceable units of the electronic cigarette.
